(19) United States
(12) Patent Application Publication
(10) Pub. No.: US 2014/0165769 A1
(43) Pub. Date: Jun. 19, 2014

(54) BRAKE LEVER

(71) Applicant: GIANT MANUFACTURING CO., LTD., Taichung Hsien (TW)

(72) Inventors: Chia-Liang HUNG, Changhua County (TW); Wei-Cheng LO, Chiayi City (TW)

(73) Assignee: GIANT MANUFACTURING CO., LTD., Taichung Hsien (TW)

(21) Appl. No.: 13/965,091

(22) Filed: Aug. 12, 2013

(30) Foreign Application Priority Data
Aug. 13, 2012 (TW) 101215585

(51) Int. Cl. B62K 23/06

(52) U.S. Cl. CPC B62K 23/06
USPC 74/488

(57) ABSTRACT

The present disclosure provides a brake lever, which include an assembling base, a lever body and a pulling portion. The assembling base is connected to the handle of the bicycle, the lever body is pivotally connected to the assembling base, and the pulling portion is connected to and protruded from the lever body. The pulling portion has a pulling surface, wherein the pulling surface is toward at least one fingertip of the rider's hand when a rider's hand holds the second holding position of the handle. When the handle of the bicycle provides two or more than two holding position, the lever body is for braking when the first holding position is held, and the pulling portion is for braking when the second holding position is held. Therefore, the rider can hold the different positions of the handle for operating the brake.

### RELATED APPLICATIONS

The application claims priority to Taiwan Application Serial Number 101215585, filed Aug. 13, 2012, which is herein incorporated by reference.

### BACKGROUND

1. Technical Field

The present disclosure relates to a brake lever. More particularly, the present disclosure relates to a brake lever with a plurality of brake holding position.

2. Description of Related Art

More and more people join the sport of cycling recently, some of them want to enjoy the easy riding but have anxiety of the design of the road bicycle handlebar. In general, the road bicycle handlebar has three sections, wherein one section is central section which is about parallel to the rider's shoulders, another section is a curved section which is connected to one end of the central section and extends along the forward direction of the road bicycle, and the other section is an end curved section which is connected to the curved section and is curved from the curved section to the ground, and the brake is usually assembled to the front side of the end curved section. The rider cannot brake when holds the central section with relax pose. When the rider wants to brake, the holding pose should be changed. However, in an emergency, the rider may too late to change the holding pose.

Therefore, an assistant brake lever is provided, which is assembled to the central section of the road bicycle handlebar, so that the rider can brake when holding the central section.

However, the assistant brake lever only provided the single brake position so that the rider can only brake when holding the central section. When the rider holds the curved section, the holding pose should also be changed when the rider wants to brake. Therefore, it is still inconvenient and unsafe.

Moreover, in general, the holding distance of the assistant brake lever is long for applying to the road bicycle, and it is unfavorable to women or the rider with smaller hand.

### SUMMARY

A brake lever is provided in the present disclosure. The brake lever provides the brake way when the rider holds different holding positions on the handle of the bicycle, and also provides shorter holding distance.

According to one embodiment of the present disclosure, a brake lever includes an assembling base, a lever body and a pulling portion. The assembling base is connected to the handle of the bicycle. The lever body pivotally is connected to the assembling base. The pulling portion is connected to and protruded from the lever body, wherein the pulling portion includes a pulling surface. The handle of the bicycle has a first holding position and a second holding position. When the rider holds the first holding position, the rider's finger can pull the lever body for braking, and holding distance is between the first holding position and the lever body; when the rider's hand holds the second holding position of the handle, the pulling surface is toward at least one fingertip of the rider's hand, so that the finger of rider's hand can pull the pulling surface of the pulling portion for braking. Therefore, the brake lever can provides different brake way when holding different holding portions by the lever body and the pulling portion.

According to another embodiment of the present disclosure, the brake lever can be connected to a road bicycle handlebar. The assembling base can be connected to the central section of the road bicycle handlebar, the axial direction of the lever body is parallel to the central section of the road bicycle handlebar, the first holding position is located on a central section of the road bicycle handlebar, the second holding position is located on a curved section of the road bicycle handlebar. Therefore, the lever body provides braking function when holding the first holding position on the central section, and the pulling portion provides braking function when holding the second holding position on the curved section. That is, the brake lever can provides different braking function when holding different holding portions of the road bicycle handlebar by the lever body and the pulling portion.

Furthermore, the length of the lever body can be changed, or a lever body angle A between the lever body and the handle can be changed, so that the shorter holding distance can be provided, wherein the holding distance is between 85 mm-95 mm according to one embodiment of the present disclosure.

The application of the present disclosure is not limited to the road bicycle handlebar, and should be applied to general handle of bicycle or various handle which has a first holding portion and a second holding portion.

The brake lever of the present disclosure can provide different braking function when holding different holding portions, and can provide shorter holding distance D1 for women or rider with smaller hand. Therefore, the braking can be easier, more convenience and the safety during riding can be increased.

### BRIEF DESCRIPTION OF THE DRAWINGS

The invention can be more fully understood by reading the following detailed description of the embodiment, with reference made to the accompanying drawings as follows:

FIG. 1 is a three-dimensional view of a brake lever connected to a road bicycle handlebar according to one embodiment of the present disclosure;

FIG. 2 shows an enlarged view of one side of the road bicycle handlebar of FIG. 1;

FIG. 3 shows a schematic view when the rider's hand holds the second holding position of the road bicycle handlebar with brake lever according to another embodiment of the present disclosure;

FIG. 4 is a schematic view of the brake lever assembled to the road bicycle handlebar with the holding distance D1;

FIG. 5A is schematic views which show a brake lever applied to one handle of a bicycle according to yet another embodiment of the present disclosure; and

FIG. 5B is schematic views which show a brake lever applied to one handle of a bicycle according to further another embodiment of the present disclosure.

### DETAILED DESCRIPTION

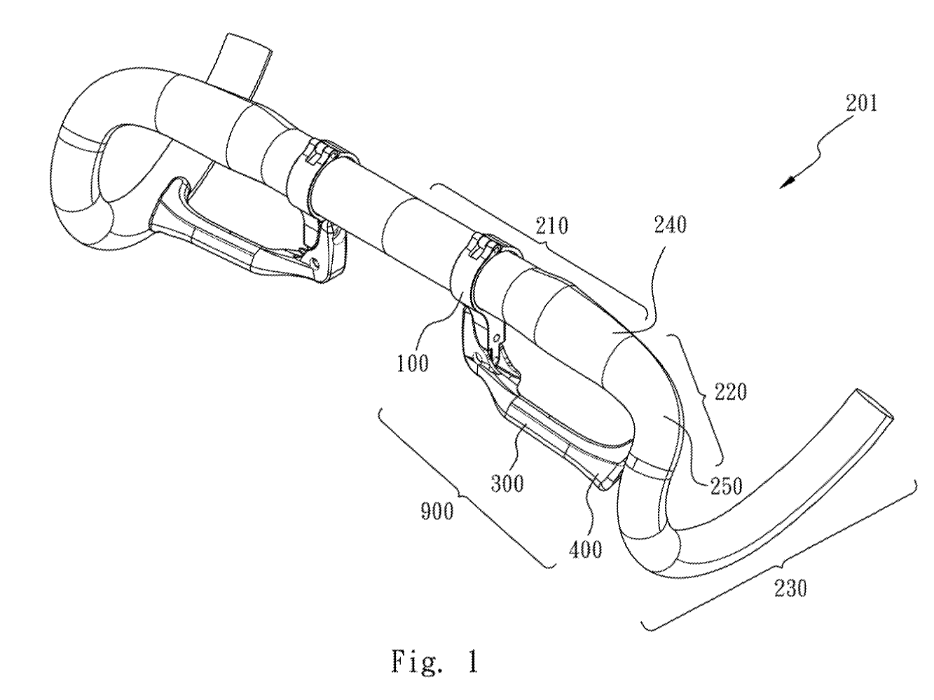

FIG. 1 is a three-dimensional view of a brake lever 900 connected to a road bicycle handlebar 201 according to one embodiment of the present disclosure, wherein the number of the element in FIG. 1 is marked on one side due to the symmetrical structure. The road bicycle handlebar 201 has three sections, wherein one section is central section 210 which is about parallel to the rider's shoulders, another section is a curved section 220 which is connected to one end of the central section 210 and extends along the forward direction of the road bicycle, and the other section is an end curved section 230 which is connected to the curved section 220 and is curved from the curved section 220 to the ground. The road bicycle handlebar 201 had a first holding position 240 located on the central section 210, and a second holding position 250 located on the curved section 220.

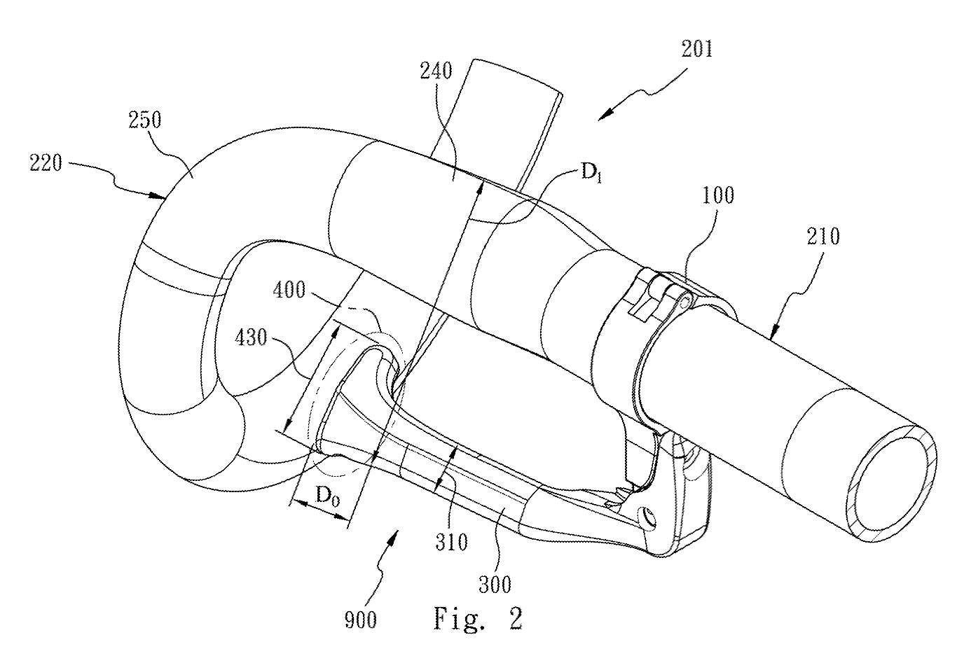

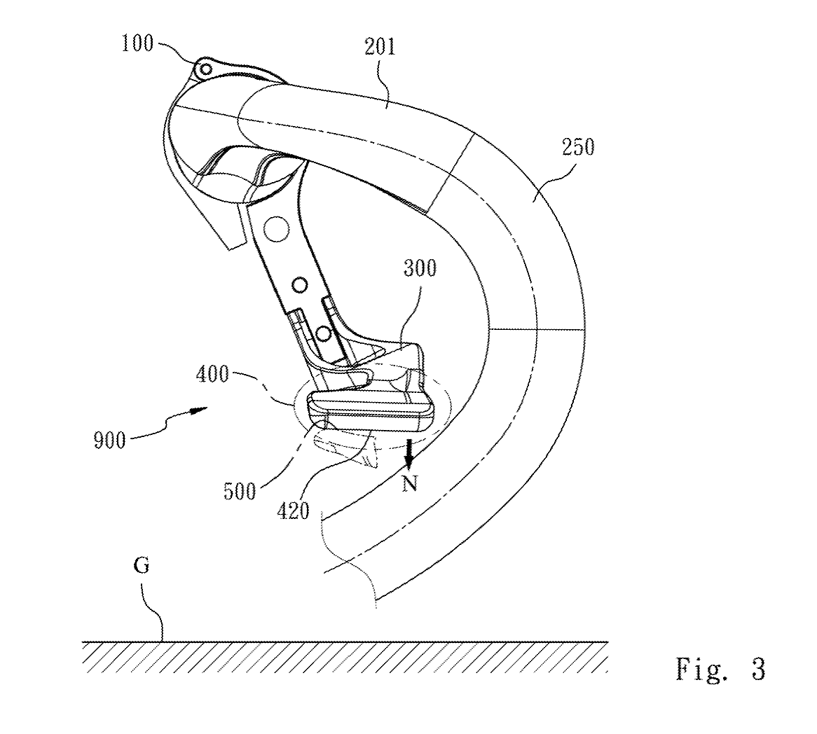

The brake lever 900 includes an assembling base 100, a lever body 300 and a pulling portion 400. Thee assembling base 100 is connected to the central section 210. The lever body 300 is pivotally connected to the assembling base 100, wherein the lever body 300 is about parallel to the central section 210. The pulling portion 400 is connected to and protruded from the lever body 300 (in FIG. 2), and the pulling portion 400 includes a pulling surface 420 (in FIG. 3).

FIG. 2 shows an enlarged view of one side of the road bicycle handlebar 201 of FIG. 1. When the rider's hand holds the first holding position 240, a holding distance D1 is between the central section 210 and the lever body 300. The holding distance D1 is measured from a position of a measured distance D0 on the outside of the lever body 300 to the outside of the central section 210, wherein the measured distance D0 can be 25 mm.

Moreover, the lever body 300 has a width 310, and the pulling portion 400 has an outer diameter 430, wherein the outer diameter 430 is the distance between two ends of the pulling portion 400. The outer diameter 430 of the pulling portion 400 is larger than the width 310 of the lever body 300.

FIG. 3 shows a schematic view when the rider's hand holds the second holding position 250 of the road bicycle handlebar 201 with brake lever 900 according to another embodiment of the present disclosure. The pulling surface 420 can be about toward a ground G along the direction N or can be toward a direction far from the lever body 300, and is toward at least one fingertip 500 of the rider's hand. When the rider's hand holds the second holding position 250, the fingertip 500 can pull the pulling surface 420, so that the lever body 300 can be pivoted by the pulling portion corresponding to the assembling base 100 for finishing the brake operation. The pulling surface 420 is a planar surface, a curved surface, or a curved surface which corresponds to the fingertip 500 of the rider's hand.

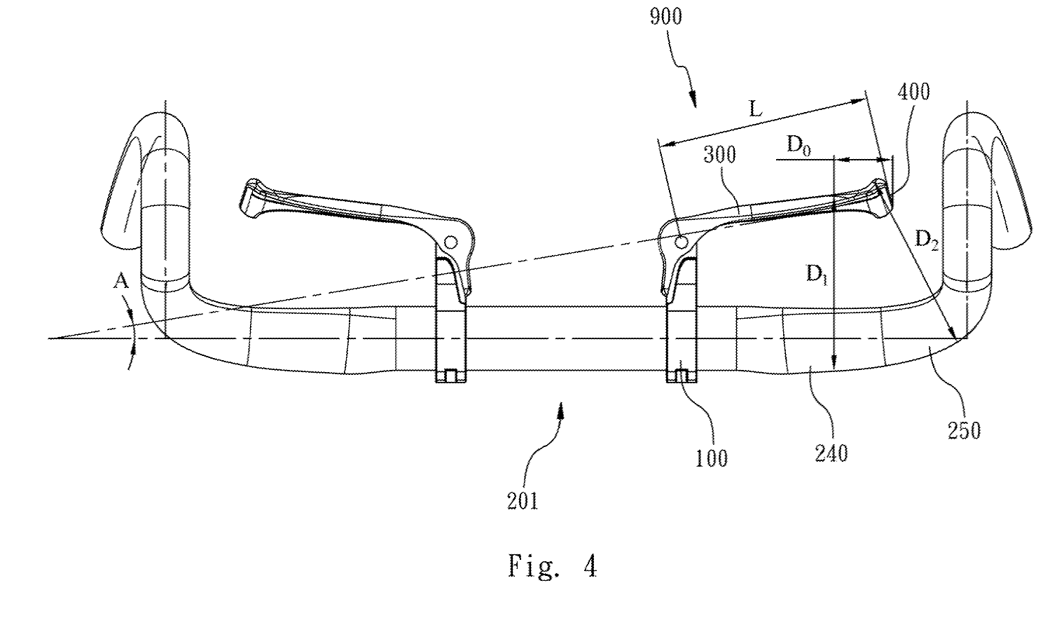

FIG. 4 is a schematic view of the brake lever 900 assembled to the road bicycle handlebar 201 with the holding distance D1, wherein the lever body 300 has a length L, and a lever body angle A corresponding to the assembling position of the assembling base 100 on the road bicycle handlebar 201. The holding distance D1 is the proper distance between the first holding position 240 and the lever body 300, so that the rider can hold the first holding position 240 for operating the brake. The pulling distance D2 is from the outside of the pulling portion 400 to the curved section 220 (the second holding position 250 is located thereon which is shown in FIG. 1). The pulling distance D2 is the proper distance between the second holding position 250 and the pulling portion 400, so that the rider can hold the second holding position 250 for operating the brake.

The holding distance D1 can be adjusted by changing the lever body angle A. The smaller the lever body angle A is, the shorter the holding distance D1 is. Furthermore, the pulling distance D2 can be adjusted by changing the length L of the lever body 300 The longer the length L of the lever body 300 is, the shorter the pulling distance D2 is. Therefore, the holding distance D1 and the pulling distance D2 can be held in an ideal range. In this embodiment, the holding distance D1 is between 85-95 mm, such as 86.7 mm; and the pulling distance D2 can be operated by the finger of the hand which hold the second holding position 250.

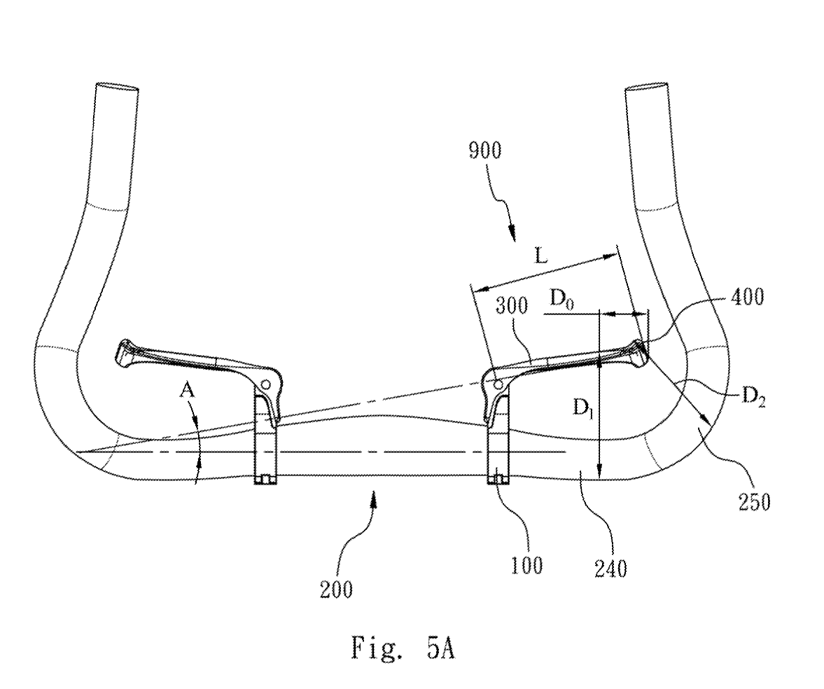

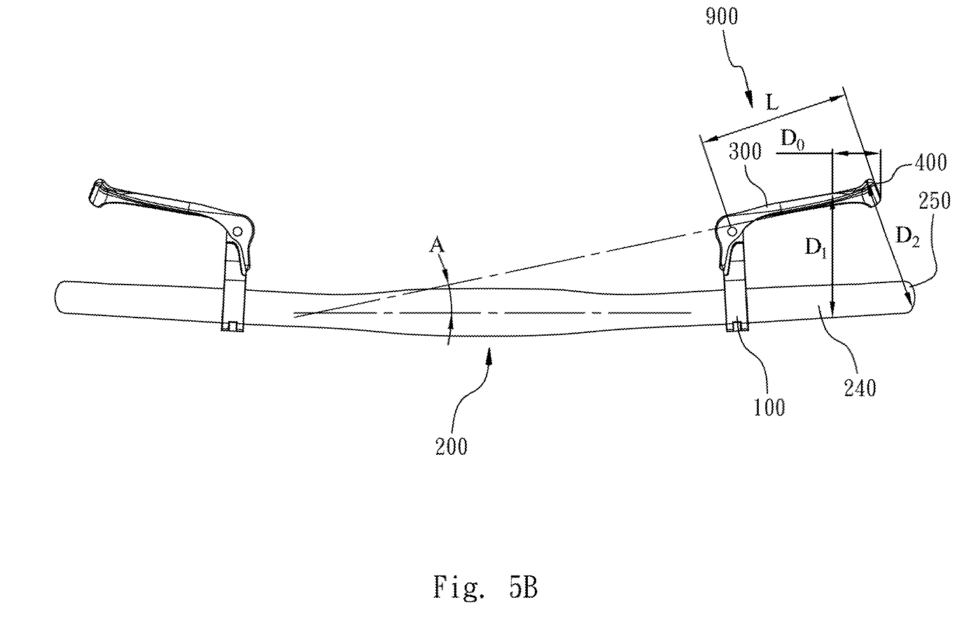

FIGS. 5A and 5B are schematic views which show a brake lever 900 applied to different handles of bicycles according to other embodiments of the present disclosure. The application of the brake lever 900 of the present disclosure not only can be applied to the road bicycle handlebar (in FIGS. 1-4), but also can be applied to various handles 200 of bicycles. When the brake lever 900 is applied to the handle 200 of the bicycle with the first holding position 240 and the second holding position 250, a holding distance D1 and a pulling distance D2 can be provided. The holding distance D1 is measured from a position of a measured distance D0 on the outside of the lever body 300 to the outside of the handle 200, wherein the measured distance D0 can be 25 mm. The pulling distance D2 is from the outside of the pulling portion 400 to the second holding position 250 which is located on the outside of the handle 200. By adjusting the lever body angle A and the length L of the lever body 300, the holding distance D1 and the pulling distance D2 can be held in an ideal range.

Moreover, the connection of the pulling portion 400 and the lever body 300 is not limited to the way disclosed in the aforementioned embodiments of the present disclosure. The pulling portion 400 also can be screwed, pivotally connected, embedded or fastened to the lever body 300.

According to the aforementioned embodiments of the present disclosure, the braking can be easier, more convenience and the safety during riding can be increased by the following advantages:

1. The rider can hold the different positions of the handle 200 for normally operating the brake.

2. The shorter holding distance D1 can be provided, so that women or rider with smaller hand can easily operate.

3. The proper pulling distance D2 can be provided, so that the different purposes and demands can be satisfied.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A brake lever, which is connected to a handle of a bicycle, wherein the handle has a first holding position and a second holding position, the brake lever comprising:
an assembling base connected to the handle of the bicycle;
a lever body pivotally connected to the assembling base, wherein a holding distance is between the first holding position, and the lever body; and
a pulling portion connected to and protruded from the lever body, the pulling portion having:
a pulling surface, wherein when a rider's hand holds the second holding position of the handle, the pulling surface is toward at least one fingertip of the rider's hand.

2. The brake lever of claim 1, wherein the handle of the bicycle is a road bicycle handlebar, the first holding position is located on a central section of the road bicycle handlebar, the second holding position is located on a curved section of the road bicycle handlebar, the assembling base is connected to the central section of the road bicycle handlebar, and the lever body is parallel to the central section of the road bicycle handlebar.

3. The brake lever of claim 1, wherein the holding distance is between 85 mm-95 mm.

4. The brake lever of claim 8, wherein the holding distance is 86.7 mm.

5. The brake lever of claim 1, wherein the pulling surface is toward a ground.

6. The brake lever of claim 1, wherein the pulling surface is toward a direction far from the lever body.

7. The brake lever of claim 1, wherein the pulling portion has an outer diameter, and the lever body has a width, wherein the outer diameter of the pulling portion is larger than the width of the lever body.

8. The brake lever of claim 1, wherein the pulling surface is a planar surface.

9. The brake lever of claim 1, wherein the pulling surface is a curved surface which corresponds to the fingertip of the rider's hand.

10. The brake lever of claim 1, wherein the pulling portion is integratedly connected to the lever body.

11. The brake lever of claim 1, wherein the pulling portion is screwed, pivotally connected, embedded or fastened to the lever body.
